(19) United States
(12) Patent Application Publication
(10) Pub. No.: US 2021/0406128 A1
(43) Pub. Date: Dec. 30, 2021

(54) CLOUD STORAGE SYSTEM

(71) Applicant: Eric Wiley, Sarasota, FL (US)

(72) Inventor: Eric Wiley, Sarasota, FL (US)

(21) Appl. No.: 17/339,307

(22) Filed: Jun. 4, 2021

Related U.S. Application Data
(60) Provisional application No. 63/043,595, filed on Jun. 24, 2020.

(51) Int. Cl. G06F 11/14; H04W 76/10; H04L 29/08; G01S 15/96

(52) U.S. Cl. CPC G06F 11/1448; G01S 15/96; H04L 67/1097; H04W 76/10

(57) ABSTRACT

Systems and methods for storing, analyzing, and remotely accessing fishing related data collected by a fish finder device are described. A fishing data management system is wirelessly connected to the fish finder device by an electronic communication connection. A mobile electronic device may be used to facilitate the electronic communication connection. The communication may be directed to the system wirelessly through a cellular, Bluetooth, or satellite navigation connection. The fishing management system is configured to receive and store data collected by the fish finder, analyze the data, and provide feedback to a user. A method of using the system allows the user to access the stored and analyzed data remotely.

### CROSS-REFERENCE TO RELATED APPLICATION

The present application claims priority to, and the benefit of, U.S. Provisional Application No. 63/043,595, which was filed on Jun. 24, 2020 and is incorporated herein by reference in its entirety.

### BACKGROUND

The present invention generally relates to a storage solution for fish finder data, and more specifically to a system to back up, save, and access fish finder data remotely. Accordingly, the present specification makes specific reference thereto. However, it is to be appreciated that aspects of the present invention are also equally amenable to other like applications, devices and methods of manufacture.

A fish finder is a device used by boaters and fishermen to locate fish in a body of water. Fish finders work by using a sound navigation and ranging (SONAR) system to locate the fish. A transmitter located on the boat is used to send signals in the water. The SONAR system uses the aspect of echoes to reflect back the waves to the transmitter. The reflected waves are recorded, and a signal is sent to a display. In order to make sure the signals received are not false signals, the waves coming after getting reflected from fish are displayed differently as compared to those coming from stones, corals or other underwater obstructions. Thus, echoes differ in size and form when there are fish in the water unlike when the water is clear of fish. Things other than fish are typically displayed with different symbols. Once a fish or school of fish is located with the SONAR, the fish finder displays the location of the fish on a graphical display such as a digital screen indicating position and depth. The display screen shows the presence of a fish in the water with the help of a symbol typically in the form of a fish.

While fish finders make fishing more enjoyable for sport fisherman, they are much more important for commercial fishermen. Commercial fishing relies on this technology to save time and money by not only finding the fish but saving the data to find patterns for future fishing. Data is built up over time and fishermen create charts based on historical data, locations, temperature variations, and other seasonal data. The loss of this data, often collected over many years, is potentially economically catastrophic.

Fish finders can be stolen, lose power, be dropped overboard, or be otherwise damaged or disabled resulting in the loss of data such as coordinates. Corroding digital memory storage devices, such as secure digital (SD) cards or other removable memory devices can fail leading to malfunctioning fish finders and the loss of the collected data. People currently have no convenient way of backing up the collected data from their fish finder locations and coordinates. Typically, fisherman would have to remove either the fish finder device or the memory device and upload it to a computer later. Unfortunately, a failed or damaged memory device may mean that this data is lost forever.

Before the invention of digital data collection, fishermen would have to manually enter the fishing data as they collected it in a permanent physical format such as a ship's log or fishing journal. This requires the fisherman to stop fishing and write down the information as it is gathered. Unfortunately, handwritten logs are difficult to quickly and easily search or evaluate for fishing patterns. The digital data collection ability of fish finders solves these problems, but the information is useless if it is lost.

In this manner, the improved data storage solution of the present invention accomplishes all of the forgoing objectives, thereby providing an easy solution for recreational or commercial fishermen to automatically save and back up their data collected by a fish finder. A primary feature of the present invention is a remote data storage solution that allows users to store their fishing numbers, coordinates, etc., so that the data is not lost in the event the fish finder or its memory storage is lost, stolen, or otherwise damaged. The invention allows users to cancel captain's numbers in the event the fish finder is stolen, along with an easy method of data recovery, and ensures that information stored locally on the fish finder is deleted if the power supply is interrupted and is only recoverable remotely by the owner.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises a data processing and storage system. The data processing and storage system is for use in communicating with a fish finder device. The data processing and storage system comprises an electronic communication connection and a fishing data management system. The electronic communication connection may be a cellular connection, a Bluetooth connection, or a satellite navigation connection. The data processing and storage system may further comprise a non-transitory, computer-readable medium comprising software instructions that, when executed by at least one processor, causes the processor to access the fishing data management system. The software instructions may comprise an App storable and accessible by the processing system of a mobile electronic device.

The fishing data management system comprises a communication receiving component. The communication receiving component is configured to sync or otherwise wirelessly connect with the fish finder device via the electronic communication connection through a network and upload data collected by the fish finder device. The fishing data management system further comprises a database for remotely storing data collected by the fish finder device. The fishing data management system further comprises an analytics component for analyzing the data. The fishing data management system further comprises a feedback component. The feedback component is configured to access the stored data and analyzed data from the database and then provide feedback based on the stored data and analyzed data to a remote user upon request.

The fishing data management system may further comprise a data tracking component for tracking the collected data. The collected data may be data representing navigational routes or coordinates, other geographical data, or a variety of other fishing information data. The fishing data management system may further comprise a locating component for locating the fish finder device. The locating component may be configured to erase locally stored data on the fish finder device remotely. The fishing data management system may further comprise an updating component for updating the fish finding device.

In an additional embodiment, a computer implemented method is provided for automatically remotely storing and accessing data collected by a fish finder device. The method comprises the steps of syncing the fish finding device to a fishing data management system via an electronic communication connection. The connection may be made through a non-transitory, computer-readable medium comprising software instructions storable on a mobile electronic device. The data is then uploaded to the fishing data management system and stored in a database. The stored data may be analyzed, tracked, and accessed remotely as feedback.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a diagrammatic view of one embodiment of a data processing and storage system of the present invention for communicating with a fish finder device in accordance with the disclosed architecture.

FIG. 2 illustrates a block diagram showing a fishing data management system of the present invention in accordance with the disclosed architecture.

FIG. 3 illustrates a flowchart of computer implemented method of the present invention for automatically remotely storing and accessing data collected by a fish finder device in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They do not intend as an exhaustive description of the invention or do not limit the scope of the invention. Additionally, an illustrated embodiment need not have all the aspects or advantages shown. Thus, in other embodiments, any of the features described herein from different embodiments may be combined.

The present invention, in one exemplary embodiment, is a cloud storage system for fish finder data, such as fishing coordinates. The software stores a user's numbers and fish finder locations after input into the system. There is a cloud based storage that allows the user to cancel numbers in the event the fish finder is lost or stolen. The numbers can be easily recovered when the owner accesses their specific cloud account. There is also a method of deleting information stored on the fish finder in the event of a power supply interruption. The data would still be recoverable remotely via the cloud storage system. The system is configured to prevent fish finder locations and collected data from being permanently lost or deleted.

The system is constructed to automatically sync data from a Fish Finder/GPS system on a boat or ship to the cloud via a connected device, such as a smartphone, or other connected communication device, or through the Fish Finder's/GPS's dedicated wireless connection. This collected data can be viewed and analyzed at any time from any connected device via the system. The system can be designed to integrate with current Fish Finder/GPS systems or potentially integrated into a standalone Fish Finder/GPS.

The system is configured to sync, track, and store multiple data points remotely for later analysis. Collected data may include detailed route information, speed of travel, fuel consumption, weather, catch weights, and fishing spot location. The global positioning system (GPS) information for every trip will be synced to the system allowing easy access to a previous route, fishing spot or any previously travelled path. The system can store the length of a trip, along with the time of day in addition to the travel speed. Measuring and tracking fuel consumption will help commercial ships streamline routes as well as help smaller boats provide more efficient routes to fishing locations. Current fish finders typically rely on SD cards to store this information. The present invention instantly saves this data remotely.

The system may include an emergency services connection. With a satellite internet connection, ships are in continuous communication with the system. Fleets may coordinate and information can be synced across the fleet of ships in real time with coordinates and speed, so fleets always know where sister ships are located. In in the event of emergencies the system will show the exact path travelled of any vessel in question with time and date stamps to help emergency services locate a vessel in duress. The system is configured to store any fishing related information collectable by the fish finder device including time of day, tide levels, weather, and vessel location so the user may easily determine the best fishing options saving time and increasing profitability.

The system is further configured to automatically update the synced fish finder with maps and other nautical information. Information may be shared with other users as desired. The system may also provide an intelligent species search on the fish finder device. The user can access the collected data to determine the best location and time to locate a desired species of fish.

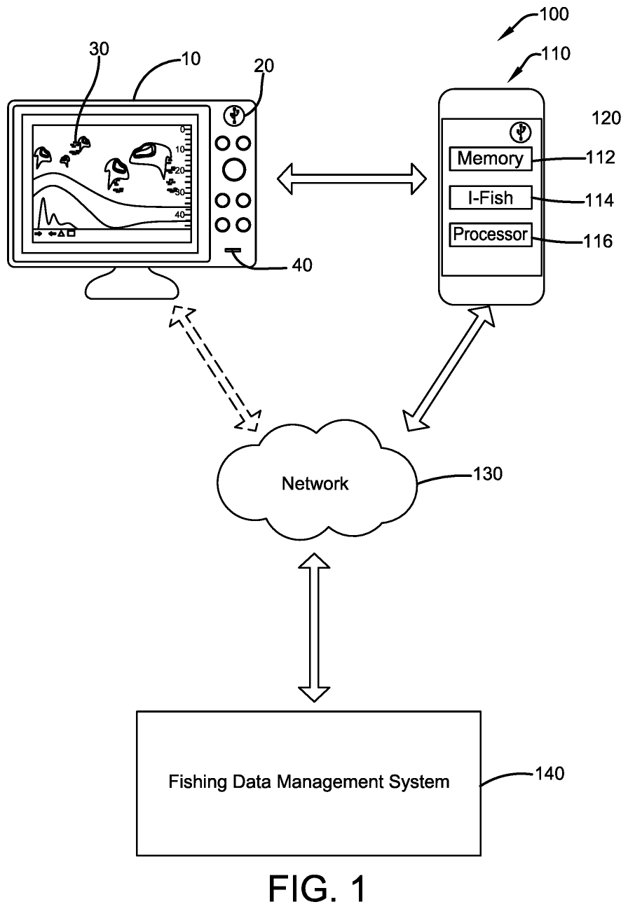

Referring initially to the drawings, FIG. 1 illustrates a data processing and storage system 100. The data processing and storage system 100 is for use in communicating with a fish finder device 10. The fish finder device 10 may be any commercially available fish finder, fish locator, SONAR system, GPS system, depth finder, water navigation device, or the like. The fish finder device 10 will typically collect data 30 and store the collected data 30 on a local memory 40, such as a SD card, removable memory stick or card, a USB memory device, or the like. The fish finder device 10 communicates via a wireless connection 20.

The data processing and storage system 100 comprises an electronic communication connection 120 and a fishing data management system 140. The electronic communication connection 120 may be a cellular connection, a Bluetooth connection, or a satellite navigation connection. The data processing and storage system 100 may further comprise a non-transitory, computer-readable medium 110 comprising software instructions 114 that, when executed by at least one processor 116, causes the processor 116 to access the fishing data management system 140. The software instructions 114 may be an App storable and accessible by the processing system 116 of a mobile electronic device 110, such as a smart phone, a smart tablet, a Long-Term Evolution (LTE) device, a NavSat device, a laptop computer, a wirelessly connected mobile device, or the like. A passcode or secure login may be used to protect access to the fish finder device 10 and prevent unauthorized usage.

With the NavSat connection, the fishing data management system 140 is continuous communication with the fish finder device 10 in real time. The collected data 30 would be accessible remotely from any connected device anywhere allowing the real time tracking and monitoring of ships and analytical data. A cellular connection similarly provides a continuous connection, but at lower cost. The cellular connection may be limited to closer to shore destinations as it is reliant on cell towers. If the real time connection is lost for any reason, the data is instantly synced to the fishing data management system 140 once the connection is reestablished. With the Bluetooth connection, a Bluetooth device, such as a smart phone is synced to the fishing data management system 140. Once synced, the phone would use a cellular connection to transmit data to the fishing data management system 140 and then back to any other connected device at a greatly reduced cost. Even if the Bluetooth device does not have a data connection, all the data is saved locally on the Bluetooth device until it re-established a connection with fishing data management system 140.

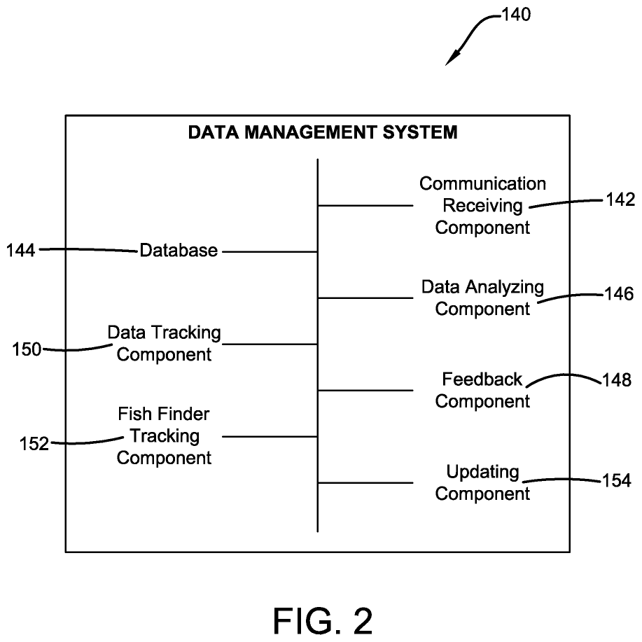

As illustrated in FIG. 2, the fishing data management system 140 comprises a communication receiving component 142. The communication receiving component 142 is configured to sync or otherwise wirelessly connect with the fish finder device 10 via the electronic communication connection 120 through a network 130. The fishing data management system 140 can sync with the fish finder device 10 via the non-transitory, computer-readable medium 112 comprising software instructions 144 storable on a mobile electronic device 110. The communication receiving component 142 uploads the data collected by the fish finder device 10. The fishing data management system 140 further comprises a database 144 for remotely storing the uploaded data collected by the fish finder device 10.

The fishing data management system 140 further comprises an analytics component 146 for analyzing the data collected by the fish finder device 10. The analytics component 146 can analyze data related to travel speed, fishing time, fuel consumption, tidal data, nautical information, or the like to allow the user to optimize future fishing trips. The fishing data management system 140 further comprises a feedback component 148. The feedback component 148 is configured to access the stored data and the analyzed data from the database 144 and then provide feedback based on the stored data and analyzed data to a remote user upon request. For example, the user could access data related to a prior fishing trip on a smartphone while planning the next trip at home.

The fishing data management system 140 may further comprise a data tracking component 150 for tracking the collected data. The collected data may be data representing navigational routes or coordinates, other geographical data, or a variety of other fishing information data, such as, but not limited to time of day, tidal levels, weather conditions, depth, fish species, bait, and fish size and weight as discussed supra. The data tracking component 150 used in conjunction with the analytics component 146 allows the user to specifically customize fishing expeditions to match expectations.

The fishing data management system 140 may further comprise a fish finder device locating component 152 for locating the fish finder device 10. If the fish finder device 10 is lost or stolen, the fish finder device locating component 152 can be used to indicate a current or last known position of the fish finder device 10. The fish finder device locating component 152 may be configured to erase locally stored data 30 on the fish finder device 10 remotely. If the fish finder device 10 is stolen or loses power, the user can remotely access the fish finder device 10 and permanently erase the collected data 30 stored on the local memory 40 or on the fish finder device 10 itself preventing unauthorized access to the collected data 30 once reconnected to the internet.

The fishing data management system 140 may further comprise an updating component 154 for updating the fish finding device 10. The updating component 154 may be used to automatically update the fish finding device 10 with current mapping and nautical information so that the user is not required to manually update the fish finder device 10. The updating component 154 may also be able to update operating software for the fish finder device 10 using a LTE or Bluetooth connection.

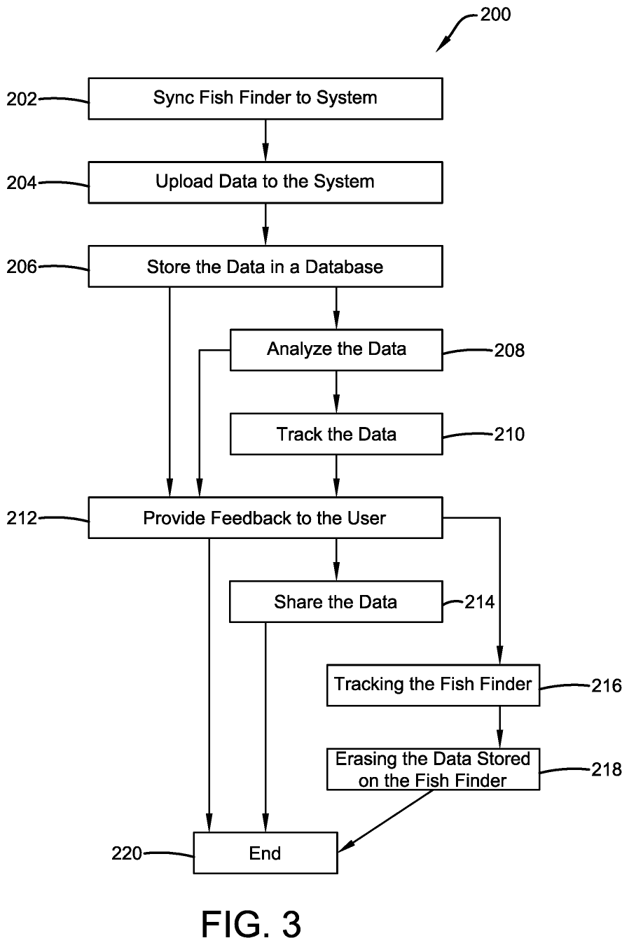

FIG. 3 illustrates a computer implemented method for automatically remotely storing and accessing data collected by a fish finder device 200. The method 200 begins by syncing the fish finder device 10 to a fishing data management system 140 via an electronic communications connection 120 at 202. The electronic communications connection 120 may be a cellular connection, a Bluetooth connection, or a satellite navigation connection. The electronic communications connection 120 may be made through a non-transitory, computer-readable medium 112 comprising software instructions 114 storable on a mobile electronic device 110. The set of software instructions 114 may be in the form of a mobile App loaded on a smart phone.

Once synced, at 204 data collected by the fish finding device 10 is uploaded to the fishing data management system 140 and stored in a database at 206. The stored data may then be accessed remotely as provided feedback to the user upon request at 212. Alternatively, the stored data may then be analyzed at 208 tracked at 210, or both as desired as discussed supra. After analysis or tracking, the data may then be similarly accessed remotely as provided feedback to the user upon request at 212.

The method may continue at 214 by allowing the user to share the collected data with other authorized users. Alternatively, the fishing data management system 140 may track the fish finding device 10 in the event it is lost or stolen. If stolen or the power supply to the fish finding device 10 is interrupted, at 218 the fishing data management system 140 instructs the fish finding device 10 to erase the collected data locally stored on the fish finding device 10. The method then ends at 220.

It is contemplated that the data processing and storage system 100, the fishing data management system 140, and the method for automatically remotely storing and accessing data collected by a fish finder device 200 constructed in accordance with the present invention will be tailored and adjusted by those of ordinary skill in the art to accommodate various levels of performance demand imparted during actual use. Accordingly, while this invention has been described by reference to certain specific embodiments and examples, it will be understood that this invention is capable of further modifications. This application is, therefore, intended to cover any variations, uses or adaptations of the invention following the general principles thereof, and including such departures from the present disclosure as come within known or customary practice in the art to which this invention pertains and fall within the limits of the appended claims.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A data processing and storage system for communicating with a fish finder device, the data processing and storage system comprising:
an electronic communication connection; and
a fishing data management system configured to:
sync with the fish finder device via the electronic communication connection;
upload and remotely store data collected by the fish finder device;
track and analyze the collected data; and
provide remote access to the collected data.

2. The data processing and storage system of claim 1 further comprising a non-transitory, computer-readable medium comprising software instructions that, when executed by at least one processor, causes the processor to access the fishing data management system.

3. The data processing and storage system of claim 2, wherein the at least one processor is a processing system of a mobile electronic device.

4. The data processing and storage system of claim 1, wherein the electronic communication connection is a cellular connection.

5. The data processing and storage system of claim 1, wherein the electronic communication connection is a Bluetooth connection.

6. The data processing and storage system of claim 1, wherein the electronic communication connection is a satellite navigation connection.

7. The data processing and storage system of claim 1, wherein the fishing data management system is further configured to permanently erase the collected data locally stored on the fish finder device.

8. A fishing data management system comprising:
a communication receiving component for receiving data collected by a fish finder device;
a database for storing the collected data;
an analytics component for analyzing the collected data; and
a feedback component for remotely accessing the stored collected data and the analyzed collected data and providing feedback upon a request.

9. The fishing data management system of claim 8, wherein the fishing data management system syncs with the fish finder device via a non-transitory, computer-readable medium comprising software instructions storable on a mobile electronic device.

10. The fishing data management system of claim 8 further comprising a data tracking component that tracks the collected data.

11. The fishing data management system of claim 8, wherein the collected data represents navigational routes and coordinates.

12. The fishing data management system of claim 8, wherein the collected data is fishing information representing at least one of time of day, tidal levels, weather conditions, depth, fish species, bait, and fish size and weight.

13. The fishing data management system of claim 8 further comprising a fish finding device locating component for providing a location of the fish finding device.

14. The fishing data management system of claim 8, wherein the analytics component is configured to analyze at least one of travel speed, fishing time, fuel consumption, tidal data, or nautical information.

15. The fishing data management system of claim 8 further comprising an updating component for updating the fish finding device with current mapping and nautical information.

16. A computer implemented method for automatically remotely storing and accessing data collected by a fish finder device comprising the steps of:
syncing the fish finder device to a fishing data management system;
uploading data collected by the fish finder device to the fishing data management system;
storing the uploaded collected data in a database of the fishing data management system;
accessing the collected data remotely.

17. The method of claim 16, wherein the fishing data management system syncs with the fish finder device via a non-transitory, computer-readable medium comprising software instructions storable on a mobile electronic device.

18. The method of claim 16 further comprising the step of analyzing the collected data and providing feedback upon a request.

19. The method of claim 16 further comprising the step of sharing the collected data.

20. The method of claim 16 further comprising the step of erasing the collected data locally stored on the fish finder device if power to the fish finder device is interrupted.
